(19) United States
(12) Patent Application Publication
(10) Pub. No.: US 2010/0151305 A1
(43) Pub. Date: Jun. 17, 2010

(54) BATTERY COVER LATCH ASSEMBLY

(75) Inventor: ZHI-BIN OUYANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/564,165

(22) Filed: Sep. 22, 2009

(30) Foreign Application Priority Data
Dec. 11, 2008 (CN) 200810306188.7

(51) Int. Cl. H01M 2/10

(52) U.S. Cl. 429/97

(57) ABSTRACT

A battery cover latch assembly comprises a battery housing member, a battery cover, a release and an elastic member. The battery housing member has a latching block protruding from one end thereof. The battery cover has a catch located at one end thereof corresponding to the latching block and a clasp located at another end thereof opposite to the catch. The release is mounted at another end of the battery housing member opposite to the latching block. The release has a latching portion protruding therefrom. The elastic member is mounted between the release and the battery housing member. The latching portion of the release latches the clasp of the battery cover, and when the release is depressed, the clasp is ejected from the latching portion, and the elastic member is compressed to generate an elastic force to return the release.

### BACKGROUND

1. Technical Field

The exemplary disclosure generally relates to latch assemblies, particularly to a battery cover latch assembly used in portable electronic devices.

2. Description of Related Art

As a power source, batteries are widely used in portable electronic devices, such as personal digital assistants (PDAs), cellular phones and others. Conventional batteries are received in the electronic devices, and battery covers are designed to connect with housings of the electronic devices to retain the batteries in place. The batteries are replaced by opening or removal of the battery cover as needed.

A clasp or latch structure is used with a conventional battery cover to engage a housing of a portable electronic device. For example, a latch can include a pair of hooks at one end of the battery cover and a locking pin protruding from the other. Accordingly, a pair of grooves is defined in one end portion of a backside of a housing of the device, and a locking hole is defined in the other. During assembly, the hooks are received in the grooves. The battery cover is pressed downwardly until the locking pin on the battery cover is received in the locking hole in the backside of the housing. The battery cover is thus assembled to the housing. However, during disassembly, the battery cover is easily damaged, since considerable force is required thereon. It can thus be inconvenient to change a battery in device.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary battery cover latch assembly. Moreover, in the drawings like reference numerals designate corresponding parts throughout the several views. Wherever possible, the same reference numbers are used throughout the drawings to refer to the same or like elements of an embodiment.

FIG. 1 is an exploded view of an exemplary embodiment of a battery cover latch assembly including a battery housing member, a battery cover, a release, and an elastic member.

FIG. 2 is similar to FIG. 1, but shows the battery cover latch assembly in another aspect.

FIG. 3 is an assembled view of the battery cover latch assembly shown in FIG. 1.

FIG. 4 is a cross-section of the battery cover latch assembly shown in FIG. 3.

FIG. 5 is similar to FIG. 4, but shows the release module is depressed.

### DETAILED DESCRIPTION OF THE EMBODIMENTS

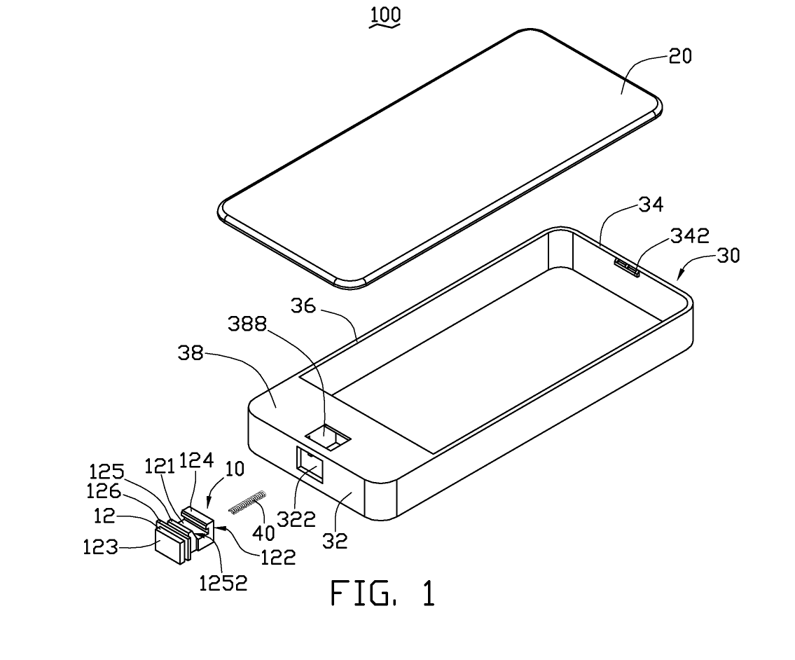

Referring to FIG. 1, an exemplary battery cover latch assembly 100 used in a portable electronic device is shown. The battery cover latch assembly 100 includes a release 10, a battery cover 20, a battery housing member 30 and an elastic member 40. The battery cover 20 is for latching to the battery housing member 30. The release 10 is mounted to the battery housing member 30. When the release 10 is pressed, the battery cover 20 is released from the battery housing member 30. The elastic member 40 is mounted between the battery housing member 30 and the release 10 and provides an elastic force for restoring the release 10 to its original state. In this embodiment, the elastic member 40 is a columnar compressed spring.

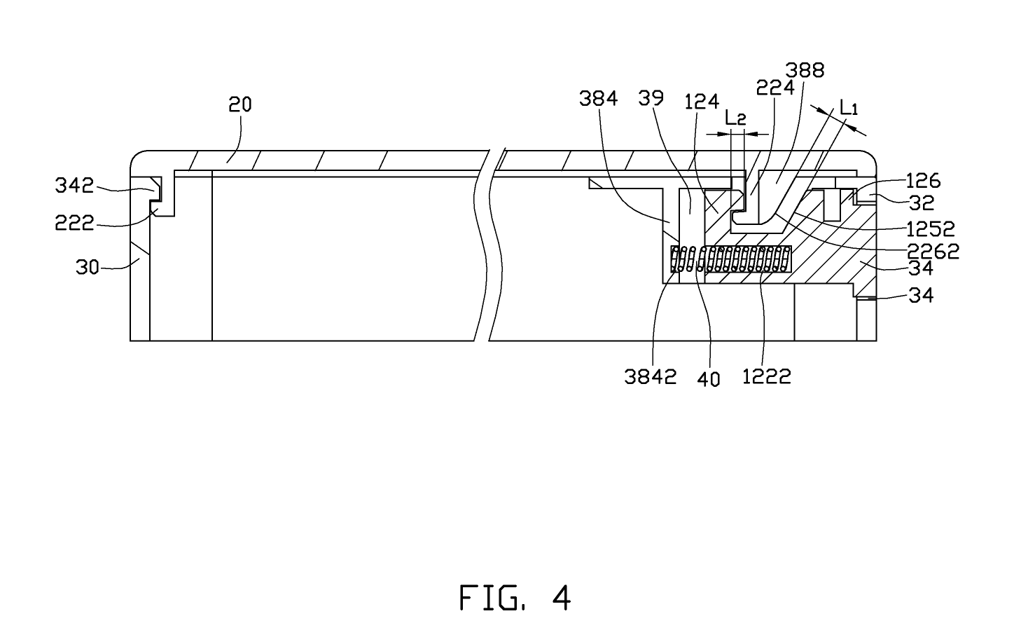

The release 10 includes main body 12. The main body 12 includes a first surface 121, a first end 122, a second end 123 opposite to the first end 122, the first surface 121 connects the first end 122 to the second end 123. The release 10 has a latching portion 124, a triggering portion 125 and a stopping portion 126 spacingly protruding from the main body 12. The latching portion 124 is a hook located at the first end 122 facing the second end 123. The latching portion 124 is configured to latch with the battery cover 20. The triggering portion 125 is located on the first surface 121 between the first end 122 and the second end 123, and the triggering portion has a first wedged surface 1252 facing the latching portion 124. The first wedged surface 1252 is configured to push the battery cover 20. The stopping portion 126 is located adjacent to the second end 123 of the main body 12 surrounding the main body 12. The stopping portion 126 is configured to prevent the release 10 from separating from the battery housing member 30. The main body 12 further has a hole 1222 (seen in FIG. 4) defined in the first end 122 accommodating the elastic member 40.

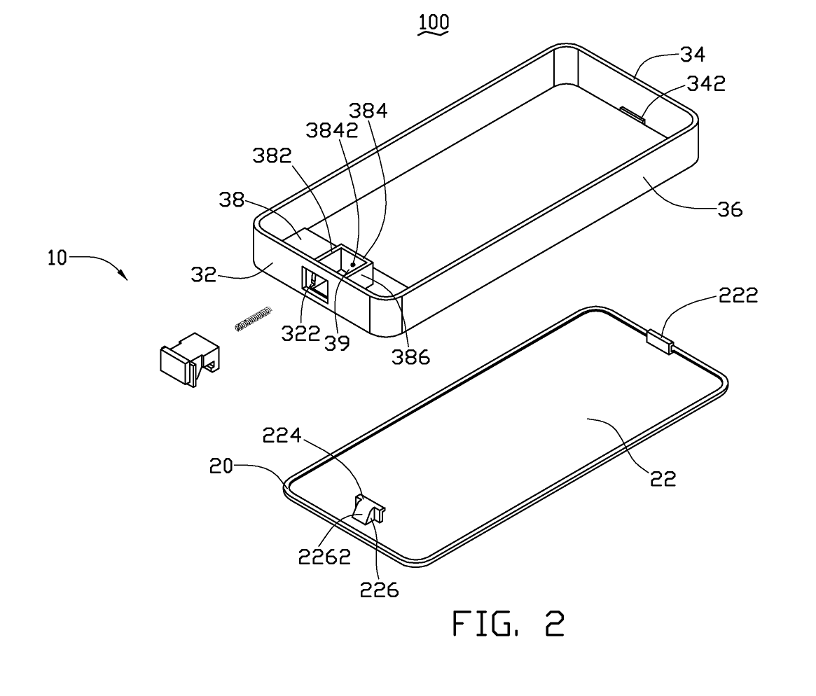

Referring to FIG. 2, the battery cover 20 has a surface 22 facing the battery housing member 30. The battery cover 20 has a catch/locking portion 222 protruding from one end thereof and a clasp 224 protruding from another. The catch 222 latches the battery housing member 30. The clasp 224 latches the latching portion 124 of the release 10. The battery cover 20 further has a wedged portion 226 protruding from a side surface of the clasp 224 facing away from the catch 222. The wedged portion 226 has a second wedged surface 2262 engaging the first wedged surface 1252.

The battery housing member 30 includes a bottom wall 38 and a plurality of sidewalls connecting therewith. The sidewalls include a first sidewall 32, a second sidewall 34 opposite to the first sidewall 32, and a third sidewall 36 connecting the first side wall 32 to the second sidewall 34. The battery housing member 30 has a mounting portion 39 in the form of a recess or cavity in the battery housing member 30. The mounting portion 39 is configured to mount the release 10 and the elastic member 40 to the battery housing member 30. The mounting portion 39 is defined by a plurality of flat planes 382, 384, 386 and the first sidewall 32, that form the surfaces of the mounting portion 39. The flat planes 382, 386 are spaced from each other and parallel to the third sidewall 36, the flat plane 384 is parallel to the first sidewall 32 and connects the flat planes 382, 384 together. The mounting portion 39 further includes a recess 3842 or projection extending from the flat plane 384 within the cavity that forms a retaining member for the elastic member 40. The battery housing member 30 further has an opening 322 defined through the first sidewall 32 and a notch 388 defined through the bottom wall 38, both of which communicate with the mounting portion 39. The opening 322 is configured to externally expose the second end 123 of the release 10. The clasp 224 of the battery cover 20 enters into the mounting portion 39 by the notch 388 to latch the latching portion 124 of the release 10. The battery housing member 30 further has a latching block 342 protruding from the second sidewall 34 corresponding to the catch 222 of the battery cover 20. The latching block 342 latches the catch 222 of the battery cover 20.

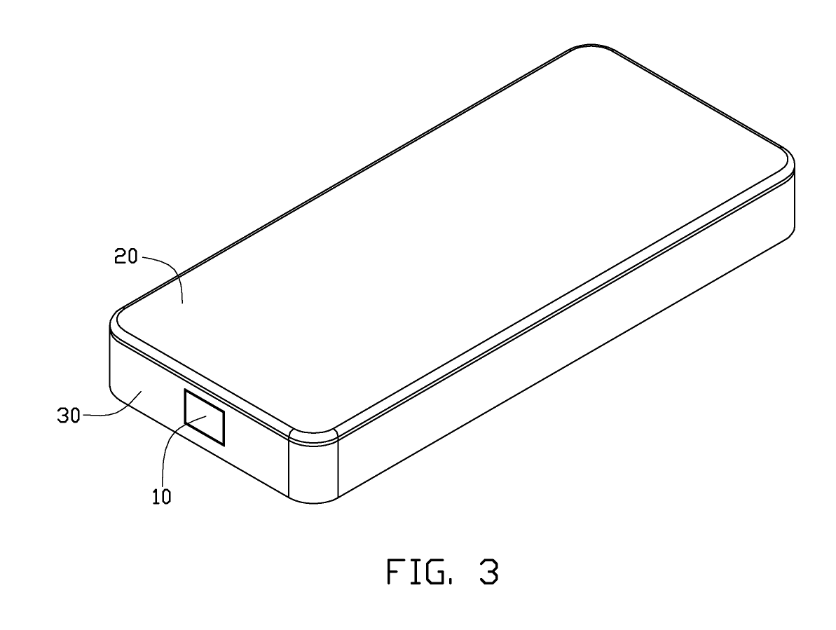

Referring to FIGS. 3 and 4, during assembly, one end of the elastic member 40 is received in the hole 1222 of the release 10. Secondly, the elastic member 40 is compressed to facilitate laying the release 10 to the mounting portion 39. Once the release 10 is in the mounting portion 39 and the elastic member 40 is aligned with the recess 3842, the elastic member 40 is released such that the other end of the elastic member 40 is locked on the recess 3842, and the second end 123 of the release 10 is received in the opening 322 until the stopping portion 126 of the release 10 is stopped by the first sidewall 32. The clasp 224 and the catch 222 respectively align with the notch 388 and the latching block 342. Battery cover 20 is pressed until the clasp 224 latches the latching portion 124 and the catch 222 latches the latching block 342, and the assembled battery cover latch assembly 100 results. At this time, the distance L1 (seen in FIG. 4) of the first wedged surface 1252 and the second wedged surface 2242 exceeds the length L2 (seen FIG. 4) between the clasp 224 and the latching portion 124.

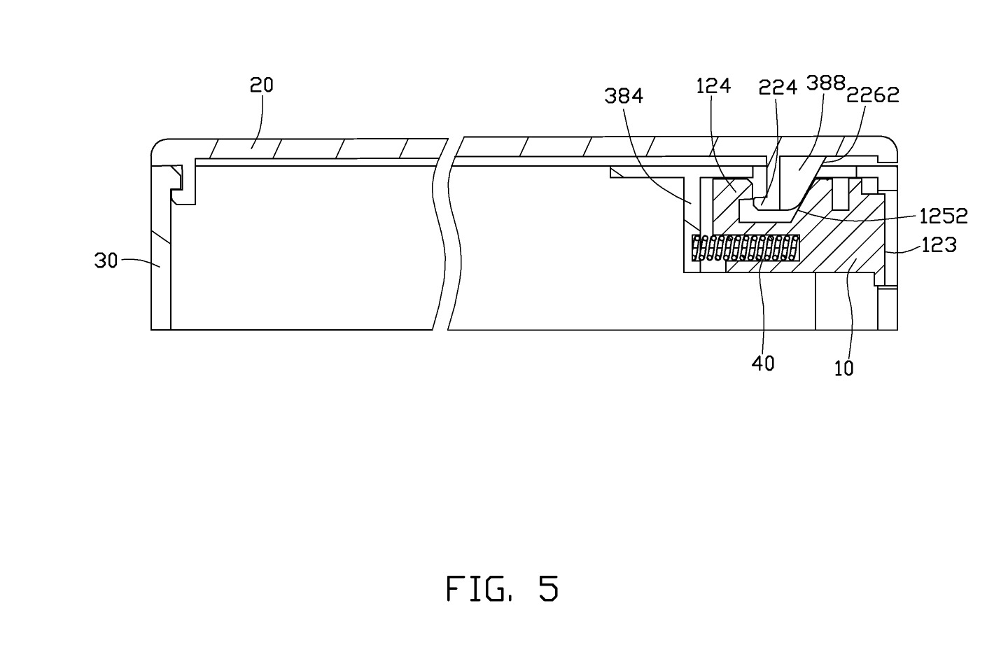

Referring to FIG. 5, when detaching the battery cover 20 from the battery housing member 30, the second end 123 of the release 10 is pressed toward the flat plane 384. At this time, the elastic member 40 is compressed to generate elastic force, the latching portion 124 is moved away from the clasp 224 of the battery cover 20. As said above, the L1 exceeds the L2, so the clasp 224 can be entirely released from the latching portion 124 before the first wedged surface 1252 resists the second wedged surface 2242. Then, the second end 123 of the release 10 is continuously pressed, such that the first wedged surface 1252 resists the second wedged surface 2262 to eject the clasp 224 from the mounting portion 39 from the notch 388, where the battery cover 20 is to be removed from the battery housing member 30.

It is to be understood, however, that even through numerous characteristics and advantages of the exemplary invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A battery cover latch assembly, comprising:
a battery housing member comprising a latching block protruding from one end thereof;
a battery cover comprising a catch located at one end thereof corresponding to the latching block and a clasp located at the other end thereof opposite to the catch;
a release slidably mounted at another end of the battery housing member opposite to the latching block, the release having a latching portion protruding therefrom, the latching portion of the release being releasably latching the clasp of the battery cover; and
an elastic member resisting between the release and the battery housing member providing elastic force.

2. The battery cover latch assembly as claimed in claim 1, wherein the release comprises a main body comprising opposite first and second ends, wherein the latching portion is located at the first end and faces the second end.

3. The battery cover latch assembly as claimed in claim 2, wherein the release further comprises a triggering portion protruding between the first end and the second end, configured to eject the battery cover from the battery housing member when the release is pressed.

4. The battery cover latch assembly as claimed in claim 3, wherein the triggering portion facing the latching portion is a first wedged surface engaging a second wedged surface formed on the clasp facing the first wedged surface such that when the first wedged surface resists the second wedged surface, the clasp is and separated from the battery housing member.

5. The battery cover latch assembly as claimed in claim 3, wherein the battery housing member comprises a mounting portion defined therein to receive the release therein

6. The battery cover latch assembly as claimed in claim 5, wherein the battery housing member further comprises an opening defined therethrough communicating with the mounting portion, through which the second end of the release is externally exposed.

7. The battery cover latch assembly as claimed in claim 6, wherein the release further comprises a stopping portion surrounding the main body and configured to resist the battery housing member to stop the release from separating from the mounting portion.

8. The battery cover latch assembly as claimed in claim 7, wherein the battery housing member comprises a first sidewall located at one end thereof and a second sidewall opposite thereto, wherein the opening is defined through the first sidewall, and the latching block protrudes from the second sidewall.

9. The battery cover latch assembly as claimed in claim 8, further comprising a bottom wall connecting with the first sidewall, on which the mounting portion is defined, and the battery housing member comprising a notch defined through the bottom wall communicating with the mounting portion such that the clasp is received in the mounting portion via the notch to latch with the latching portion of the release.

10. The battery cover latch assembly as claimed in claim 5, wherein the elastic member is mounted between the first end of the release and a surface inside the mounting portion.

11. The battery cover latch assembly as claimed in claim 10, wherein the first end of the release defines a hole and the surface inside the mounting portion defines a recess, wherein one end of the elastic member is received in the hole and another end of the elastic member is received in the recess.

12. A battery cover latch assembly, comprising:
a battery housing member comprising a latching block protruding from one end thereof;
a battery cover comprising a catch at one end thereof corresponding to the latching block and a clasp at another end thereof opposite to the catch;
a release mounted at an another end of the battery housing member opposite to the latching block, comprising a latching portion protruding therefrom, wherein the latching portion of the release latches the clasp of the battery cover; and
an elastic member mounted between the release and the battery housing member to generate elastic force;
wherein after the release is depressed to eject the clasp from the latching portion, when the release is depressed further, the release impels the battery cover away from the battery housing member.

13. The battery cover latch assembly as claimed in claim 12, wherein the release comprises a main body comprising a first end and a second end opposite thereto, and the latching portion is located at the first end facing the second end.

14. The battery cover latch assembly as claimed in claim 13, wherein the release further comprises a triggering portion protruding between the first end and the second end, configured to impel the battery cover away from the battery housing member when the release is pressed a predetermined amount.

15. The battery cover latch assembly as claimed in claim 14, wherein the triggering portion facing the latching portion comprises a first wedged surface, engaging the second wedged surface formed on the clasp facing the first wedged surface.

16. The battery cover latch assembly as claimed in claim 14, wherein the battery housing member defines a mounting portion in which the release is received.

17. The battery cover latch assembly as claimed in claim 16, wherein the battery housing member further defines an opening therethrough communicating with the mounting portion, through which the second end of the release is externally exposed.

18. The battery cover latch assembly as claimed in claim 17, wherein the release further comprises a stopping portion surrounding the main body, resisting the battery housing member and retaining the release in the mounting portion.

19. The battery cover latch assembly as claimed in claim 18, wherein the battery housing member comprises a first sidewall located at one end thereof and a second sidewall opposite to the first sidewall, the opening is defined through the first sidewall, and the latching block protrudes from the second sidewall.

20. The battery cover latch assembly as claimed in claim 19, wherein the battery housing member further comprises a bottom wall connecting with the first sidewall, in which the mounting portion is defined, defines a notch through the bottom wall communicating with the mounting portion, and the clasp enters the mounting portion by the notch to latch the latching portion of the release.
